(19) United States
(12) Patent Application Publication
(10) Pub. No.: US 2011/0125349 A1
(43) Pub. Date: May 26, 2011

(54) Integrated Bird-Aircraft Strike Prevention System - IBSPS

(76) Inventor: Danny Ace, Tacoma, WA (US)

(21) Appl. No.: 12/951,048

(22) Filed: Nov. 21, 2010

Related U.S. Application Data
(60) Provisional application No. 61/263,810, filed on Nov. 23, 2009.

(51) Int. Cl. B64D 45/00; G01S 13/93

(52) U.S. Cl. 701/14; 342/29; 342/53; 342/52

(57) ABSTRACT

An airborne apparatus that employs an advanced computer to analyze bird and aircraft positioning data, programmed to issue a warning about an impending strike, thereby creating the ultimate Bird-Aircraft Strike Prevention System. This system will constantly process the bird positioning data gathered by the Radar/Infrared sensors. In case of a bird-aircraft strike danger the system will immediately alert the pilot as well as Air Traffic Control, and, compute the necessary course correction required to avoid the collision. The advantages of the system include the ability to prevent bird strikes and instantaneously compute an alternative course or action necessary to avoid the bird-aircraft impact. Additionally, because the IBSPS is capable of being airborne, the aircraft will be protected from bird-strikes throughout the entire flight, even in absence of ground systems. Furthermore, the ability to integrate all IBSPS equipped airplanes significantly increases area coverage and enhances the safety of Air Traffic System.

### CROSS-REFERENCE TO RELATED APPLICATIONS

This application claims the benefit of provisional application No. 61/263,810, filed 2009 Nov. 23 by present inventor.

### FEDERALLY SPONSORED RESEARCH OR DEVELOPMENT

Not Applicable

### TECHNICAL FIELD OF THE INVENTION

The present invention is in the technical field of Aircraft Safety. More particularly, the invention is in the field of systems and technologies developed for bird-aircraft strike prevention. The invention is also based on technical fields of Computer Science and Radar technology.

### BACKGROUND OF THE INVENTION

Bird Strikes on Aircraft during flight, take-off and landing are a tremendous safety concern for people and aircraft. For example, a 12-lb bird struck by a 150-mph aircraft at lift-off generates the kinetic energy of a 1,000-lb weight dropped from a height of 10 feet. During last several years Bird Strikes on planes resulted in many serious incidents, emergency landings and crashes. In 2008 there were over 7500 reported bird strikes on civil aircraft. It is estimated that bird-plane collisions have increased by 40% and may pass 10,000 in 2009. The cost of these strikes is over 600 million dollars a year in the US alone.

We all remember the “Miracle on the Hudson River” on Jan. 15, 2009, when a flock of geese disabled both engines of the US Airways Flight 1549. Miraculously, the pilot was able to land the jet on the Hudson river, saving all 155 on board.

When reading about these incidents, the emergency landings, destroyed aircraft and other statistics resulting from the bird-aircraft strikes I realized this problem can be solved with modern computer, radar or infrared sensor technology. Main advantages of one or more aspects include detection of birds on a collision course with the airplane, complete prevention of bird-aircraft strikes, significant improvement of air travel safety as well as preservation of many birds including endangered and protected species. These advantages will become apparent from the following description and drawings.

### SUMMARY OF THE INVENTION

The Integrated Bird-Aircraft Strike Prevention System (IBSPS) will prevent Bird-Aircraft strikes during Flight, Takeoff and Landing of any aircraft. In case of an impending bird-aircraft strike the IBSPS will immediately alert the Pilot and Air Traffic Control. In addition, the system will provide a new course or action necessary to avoid the impact. The advantages of the system include the ability to prevent bird strikes and instantaneously compute an alternative course or action necessary to avoid the bird-aircraft impact. Additionally, because the IBSPS is capable of being airborne, the aircraft will be protected from bird-strikes throughout the entire flight and when a ground-based bird detection system is not even installed at the servicing airport. Moreover, the ability to integrate all aircraft equipped with IBSPS significantly improves the flight safety, airport operations and the Air Traffic System.

### BRIEF DESCRIPTION OF THE DRAWINGS

FIG. 1 is a Bird-Aircraft Strike Prevention System Overview, showing its major components.

FIG. 2 is diagram of the Integrated Bird-Aircraft Strike Prevention System (IBSPS).

FIG. 3 is a top view of the IBSPS equipped Airport and the Extended Area Coverage, showing how the Air Traffic is redirected to avoid bird-aircraft strike danger.

FIG. 4 is a side view of the IBSPS equipped Aircraft that Changes Course to prevent the flock of birds from damaging its engines.

### REFERENCE NUMERALS

100 Computer System
101 Bird Proximity Detector
102 Bird Positioning Data
103 Alert
104 Suggested Action/New Course
105 User
106 Air Traffic control (ATC)
107 Pilot
200 IBSPS Computer
201 Airborne BSPS
202 Alert/New Course
203 Ground BSPS
204 Air Traffic Control (ATC)
205 Pilot
206 Alerts, Action/New Course
300 Airport
301 Air Traffic Control (ATC)
302 IBSPS
303 Ground BSPS
304 Airborne BSPS
305 Flock of Birds
306 Aircraft Departing North
307 Area Coverage provided by the Ground BSPS Unit
308 Area Coverage provided by IBSPS
309 No-Fly Zone
310 Aircraft Departing West
400 Aircraft
401 Engines
402 Integrated Bird-Aircraft Strike Prevention System (IBSPS)
403 Flock of Birds
404 New Course

### DETAILED DESCRIPTION OF THE INVENTION

Integrated Bird-Aircraft Strike Prevention System (IBSPS) is a system that utilizes Radar and/or Infrared sensor technology to detect birds in proximity or on course of the aircraft during flight, takeoff or landing. Specifically, IBSPS uses an Advanced Computer system to analyze the data gathered by the radar/sensors. In case of a bird-aircraft strike danger the system will alert the Pilot as well as Air Traffic Control (ATC) and provide an alternative course or action necessary to avoid bird-aircraft impact.

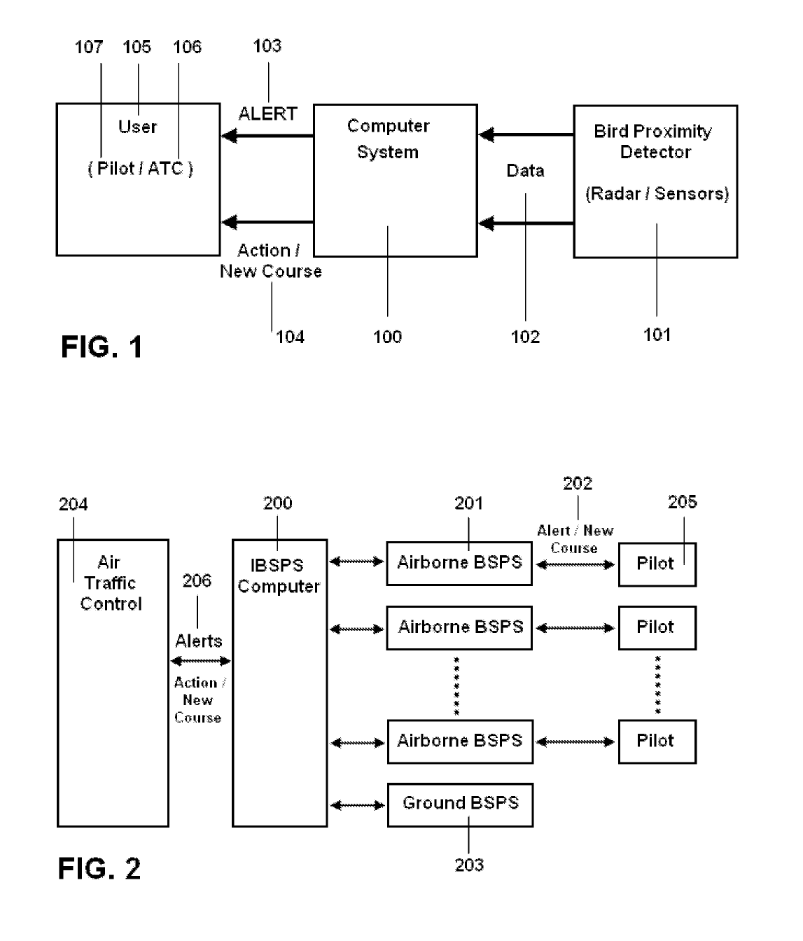

One embodiment of the Bird-Aircraft Strike Prevention System (BSPS) is illustrated in FIG. 1. This system comprises a Computer 100 that analyzes aircraft and bird positioning data 102 supplied by a Bird Proximity Detector 101. If bird-aircraft strike danger exists, the Computer System 100 issues an Alert 103 to the Pilot 107 as well as to the ATC 106 and suggests an appropriate Action or a New Course 104 to avoid the impact. The Bird Proximity Detector 101 constitutes a means for detecting birds on a flight path of the aircraft by using the Radar and/or Infrared sensors. The Computer System 100 is a real time computer that instantly processes the data provided by the Bird Proximity Detector 101 and uses algorithms to compute most suitable action or course correction 104. This saves the User 105 valuable time and enables him/her to immediately respond to the danger.

Each airborne Bird-Aircraft Strike Prevention System (BSPS) shown in FIG. 1 can function independently or be integrated with other BSPS units. The autonomous functionality of each airborne BSPS unit enables each BSPS equipped aircraft to be secure from bird strikes during the entire flight, while outside airport vicinity, and, especially when typical bird detection system is not even installed at the servicing airport. The ability of each BSPS to Integrate with other BSPS Units results in additional advantages such as increased area coverage and early issuance of bird strike warnings, significantly enhancing the Air Traffic System.

FIG. 2 displays the diagram of an Integrated Bird-Aircraft Strike Prevention System (IBSPS) system, where Airborne BSPS Units 201 installed on each aircraft and the optional Ground-based BSPS Unit 203 are integrated together. This significantly increases the land coverage and overall effectiveness of the system. The IBSPS Computer 200 analyzes the data provided by the Airborne BSPS Units 201 and the Ground BSPS Unit 203. In case of a bird-aircraft strike danger the IBSPS Computer 200 can issue an Alert/Action 206 to the Air Traffic Control (ATC) 204 or issue an Alert/New Course 202 directly to the Pilot 205.

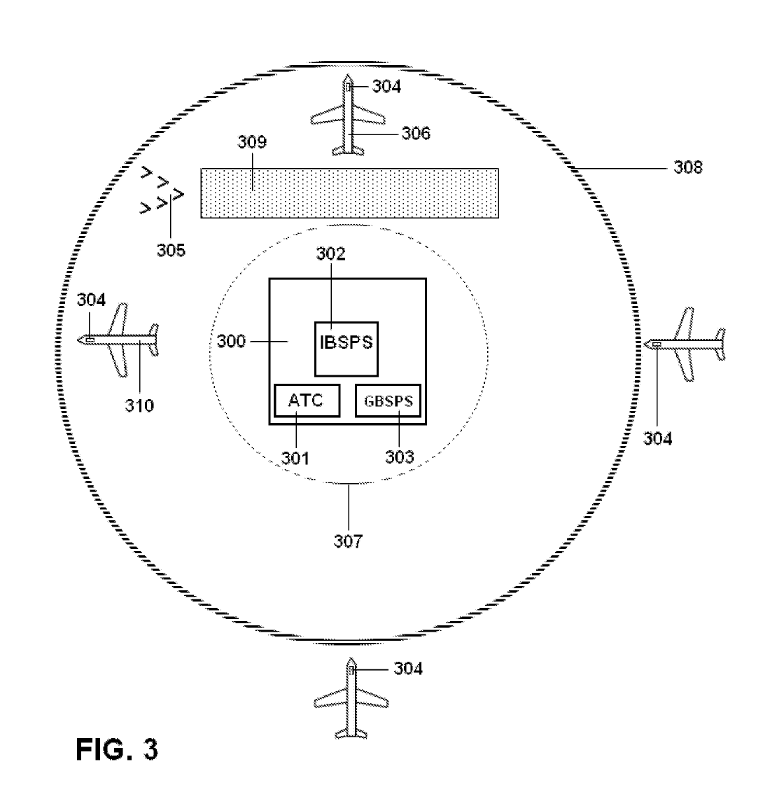

FIG. 3 illustrates the IBSPS 302 installed at Airport 300, providing an extensive picture of bird activity and maximum protection by integrating BSPS Units 304 on all incoming and departing aircraft. As a result, IBSPS Area Coverage 308 is significantly larger than an area coverage 307 provided by the Ground BSPS 303 alone. Thus, the IBSPS will enable the ATC 301 to issue early bird strike warnings, adjust the Air Traffic System and respond to bird strike danger more effectively.

### Operation

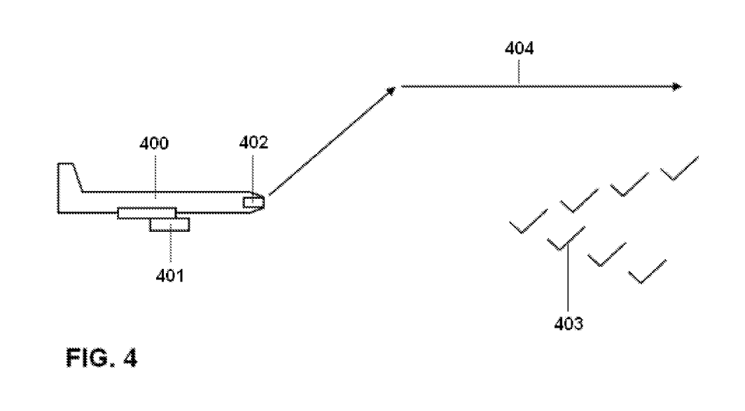

FIG. 4 shows how the IBSPS equipped airplane 400 avoids a collision with a flock of birds 403 on its path. When BSPS unit 402 detects a flock of birds 403, it alerts the pilot and computes an Alternative Course 404 necessary to prevent the bird strike. In this case, the BSPS unit 402, detailed in FIG. 1, functions independently. Specifically, in terms of FIG. 1 and FIG. 4, The Bird Proximity Detector 101 locates the bird flock 403 and provides the bird positioning data 102 to the BSPS Computer 100. The Computer 100 analyzes the data 102 and issues an Alert 103. In addition, the Computer 100 generates a new course 404 necessary to avoid a collision and provides the corrected course 404 to the pilot 107. The pilot 107 changes the course of the aircraft 400 and successfully prevents a bird-aircraft impact on the aircraft 400 or its engines 401.

All BSPS Units can also be integrated together as illustrated in FIG. 2 and FIG. 3. For example, when the IBSPS system 302 is installed at the Airport 300, it integrates airborne BSPS units 304 on all departing and arriving aircraft as well as the Ground-based BSPS 303. This results in an extended area coverage 308, enabling the Air Traffic Control (ATC) 301 to issue an early bird strike warnings and adjust the Air Traffic system accordingly.

Specifically, the airborne BSPS 201 installed on the departing aircraft 306 detects the flock of birds 305 and provides this information to the IBSPS Computer 200. The IBSPS Computer 200 issues an Alert 206 to the Air Traffic Control 204 and suggests to create a No-Fly Zone 309, temporarily suspending all take-offs in that direction (north). In addition the IBSPS 302 will display which runways need to be placed on hold or provide alternative takeoff or landing route. As a result, the ATC 301 approves the action 206 generated by the Computer 200 and issues an early bird strike Alert and Alternative take-off Course 202 for next aircraft 310. The early bird-strike alert and the new course 202, is sent via the IBSPS Computer 200 to the Airborne BSPS unit 201, which in turn provides this information to the pilot 205, who avoids the No-Fly Zone 309 and takes-off westward.

It is also possible to enable the IBSPS 302 to adjust the Air Traffic automatically, if needed, and issue alerts and course corrections 202 directly to the pilots if the situation necessitates it.

### Advantages

The advantage of enabling each airborne BSPS unit to function independently is tremendous. For example, the aircraft equipped with IBSPS will still be protected from bird strikes even when a typical ground based bird detection system is not installed at the host airport.

Another advantage of IBSPS is that it protects the aircraft at any point in time, at any stage of take-off, cruising or landing. This becomes especially significant when compared to a typical ground-based bird detections system, whose area coverage is very limited and cannot protect aircraft when they are just outside of immediate airport vicinity, making them very vulnerable.

The ability of IBSPS to integrate all airborne and ground-based BSPS Units or other components significantly improves the effectiveness of the System. This results in much larger area coverage, enabling the IBSPS to issue early bird-aircraft strike warnings and allowing Air Traffic System to respond to the bird strike dangers more effectively.

### CONCLUSION, RAMIFICATIONS AND SCOPE

Clearly, the Integrated Bird-Aircraft Strike Prevention System (IBSPS) provides a superior protection against bird strikes. The main advantages of IBSPS include, without limitation, the ability to function independently on any aircraft and secure it from bird strikes for the entire flight duration, even when the aircraft is outside the limited coverage of the typical ground-based bird detection system. Secondly, because each IBSPS equipped aircraft has the ability to detect birds and compute the necessary course correction autonomously, it can remain safe even in absence of a bird strike detection systems on the ground or at the servicing airport. In addition, the IBSPS can integrate any number of airborne or ground based BSPS Units, covering significantly more area, issuing early bird-aircraft strike warnings and routing Air Traffic more effectively.

While the above description contains many specificities, these should not be construed as limitations on the scope, but rather as an exemplification of preferred embodiments thereof. Many other variations, combinations and equivalents of the embodiments, methods and examples are possible. For example:
The IBSPS could integrate entire airports with all incoming and departing flights or all airplanes above the continent in order to issue early bird-aircraft strike warnings and adjust the Air Traffic System more effectively, reducing delays.
The means for detecting birds could be implemented by using the Radar, Infrared Sensor, Optical, Laser or other technologies.
The IBSPS could be installed anywhere or on any aircraft, including helicopters.
The IBSPS could integrate with any other equipment or system.

Thus, the scope should be determined not by the embodiments, methods and examples illustrated, but by the appended claims and their legal equivalents.

Further, the purpose of the foregoing description is to enable the U.S. Patent and Trademark Office, the public generally, and especially the scientists, engineers and those skilled in the art to appreciate that the conception, upon which this disclosure is based, may readily be utilized as a basis for the designing of other embodiments, structures, methods and systems for carrying out the purposes of the present invention. It is important, therefore, that the claims be regarded as including such equivalent constructions.

I claim:

1. An airborne bird-aircraft strike prevention apparatus, comprising:
a computer system for analyzing bird and aircraft positioning data, made to issue a warning in case of a bird-aircraft strike danger;
means for detecting birds on a flight path of an aircraft, integrated with said computer system;
whereby (a) said apparatus will alert the pilot about an impending bird-aircraft strike, (b) said apparatus will enable said pilot to respond to the situation in time, and (c) said apparatus will secure said aircraft from bird strikes.

2. The bird-aircraft strike prevention apparatus of claim 1, wherein said computer system is made to compute an alternative flight course to avoid the bird strike and provide said pilot with said alternative flight course.

3. The bird-aircraft strike prevention apparatus of claim 1, wherein said means for detecting birds are based on a radar system.

4. The bird-aircraft strike prevention apparatus of claim 1, wherein said means for detecting birds are based on optical sensors.

5. The bird-aircraft strike prevention apparatus of claim 1, further including
a ground-based computer system, and
a ground-based means for detecting birds, integrated with said ground-based computer system.

6. A bird-aircraft strike prevention apparatus, comprising:
a computer system for analyzing bird and aircraft positioning data, made to issue a warning in case of a bird-aircraft strike danger;
means for detecting birds in different locations, integrated with said computer system;
whereby (a) said apparatus will have a large area coverage, (b) said apparatus will provide a complete picture of bird activity at the airport and on approaching flights, (c) said apparatus will alert the pilot about an impending bird-aircraft strike, (d) said apparatus will enable the air traffic system to respond to the danger more effectively, and (e) said apparatus will monitor multiple aircraft and secure them from bird strikes.

7. The bird-aircraft strike prevention apparatus of claim 6, wherein said computer system is made to compute an alternative course to avoid the bird strike and provide said pilot with said alternative course.

8. The bird-aircraft strike prevention apparatus of claim 6, wherein said means for detecting birds are based on a radar system.

9. The bird-aircraft strike prevention apparatus of claim 6, wherein said means for detecting birds are based on infrared sensors.

10. The bird-aircraft strike prevention apparatus of claim 6, wherein said means for detecting birds are based on optical sensors.

11. The bird-aircraft strike prevention apparatus of claim 6, wherein said means for detecting birds are based on a radar system and optical sensors.

12. A bird-aircraft strike prevention apparatus, comprising
a radar system made to detect birds;
a computer system for processing and analyzing data gathered by said radar system, made to issue a warning in case of a bird-aircraft strike danger;
whereby (a) said apparatus will provide a complete picture of bird activity in the area covered by said radar system, (b) said apparatus will alert the pilot about an impending bird-aircraft strike, (c) said apparatus will enable said pilot and the air traffic control to respond to the situation in time, and (d) said apparatus will secure an aircraft from bird strikes.

13. The bird-aircraft strike prevention apparatus of claim 12, wherein said computer system is made to compute an alternative flight course to avoid the bird strike and provide said pilot with said alternative flight course.

14. The bird-aircraft strike prevention apparatus of claim 12, wherein said radar system is installed on said aircraft.

15. The bird-aircraft strike prevention apparatus of claim 12, wherein said radar system is installed on said aircraft and on the ground.

16. The bird-aircraft strike prevention apparatus of claim 12, further including a system of infrared sensors.

17. The bird-aircraft strike prevention apparatus of claim 12, further including a system of optical sensors.
